(19) United States
(12) Patent Application Publication
(10) Pub. No.: US 2026/0126572 A1
(43) Pub. Date: May 7, 2026

(54) DIFFRACTIVE OPTICAL DEVICE

(71) Applicant: VisEra Technologies Company Ltd., Hsin-Chu City (TW)

(72) Inventors: Huai-Yung WANG, Hsin-Chu City (TW); Po-Han FU, Hsin-Chu City (TW); Chin-Chuan HSIEH, Hsin-Chu City (TW)

(21) Appl. No.: 18/938,461

(22) Filed: Nov. 6, 2024

(51) Int. Cl. G02B 5/18; F21V 8/00; G02B 1/00

(52) U.S. Cl. CPC G02B 5/1866; G02B 1/002; G02B 6/0023

(57) ABSTRACT

A diffractive optical structure includes a waveguide, a light emitting unit, and a metasurface. The waveguide includes a first transverse surface and a second transverse surface opposite to the first transverse surface. The light emitting unit directly contacts the first transverse surface of the waveguide is configured to emit a light beam with an initial divergence angle, wherein the light emitting unit includes a light source. The metasurface is disposed on the second transverse surface of the waveguide, wherein the metasurface is configured to couple out the light beam from the waveguide and project an optical pattern on a plane, wherein the optical pattern includes a negative order diffracted light.

### BACKGROUND

### Field of Invention

The present disclosure relates to a diffractive optical device. More particularly, the present disclosure relates to the diffractive optical device coupling out a negative order diffracted light.

### Description of Related Art

A traditional meta optical element (MOE) or diffractive optical element (DOE) system usually needs a certain focal length between a light source and a waveguide to achieve diffraction, so the traditional diffractive optical device has a certain thickness, for example, hundreds of millimeters. However, traditional diffractive optical device cannot satisfy continuously shrinking diffractive optical devices. Therefore, there is a need to solve the above problems.

### SUMMARY

The present disclosure provides a diffractive optical device having a waveguide, a light emitting unit, and a metasurface, in which the light emitting unit directly contacts a transverse surface of the waveguide, so that a light beam can travel in the waveguide by total internal reflection before coupling out through the metasurface. Since the light emitting unit directly contacts the transverse surface of the waveguide, a thickness of the disclosed diffractive optical device can be reduced compared to the traditional MOE or DOE system. Therefore, the disclosed diffractive optical device can satisfy continuously shrinking diffractive optical devices.

One aspect of the present disclosure is to provide a diffractive optical device. The diffractive optical device includes a waveguide, a light emitting unit, and a metasurface. The waveguide includes a first transverse surface and a second transverse surface opposite to the first transverse surface. The light emitting unit directly contacts the first transverse surface of the waveguide configured to emit a light beam with an initial divergence angle, wherein the light emitting unit includes a light source. The metasurface is disposed on the second transverse surface of the waveguide, wherein the metasurface is configured to couple out the light beam from the waveguide and project an optical pattern on a plane, wherein the optical pattern includes a negative order diffracted light.

According to some embodiments of the present disclosure, the light source includes a vertical cavity surface emitting laser or a light emitting diode.

According to some embodiments of the present disclosure, the waveguide includes a planar waveguide or a curved waveguide.

According to some embodiments of the present disclosure, the light emitting unit further includes a surface relief grating, the surface relief grating is disposed between the light source and the waveguide and directly contacts the first transverse surface of the waveguide, and an initial emergent angle (θ₀) of the light beam in the waveguide is not 0 degree, wherein the initial emergent angle is defined by an included angle between a center line of the light beam and a normal line of the first transverse surface of the waveguide.

According to some embodiments of the present disclosure, the surface relief grating includes a plurality of slanted structures.

According to some embodiments of the present disclosure, the waveguide further includes an anti-reflection layer adjacent to the metasurface, and the anti-reflection layer is substantially perpendicular to both the first transverse surface and the second transverse surface.

According to some embodiments of the present disclosure, an incident angle of the light beam, the initial divergence angle of the light beam, and a refractive index of the waveguide satisfy the following equitation:

$${θ}_{i} - \frac{β}{2} \geq {sin}^{- 1} ( \frac{1}{n} ) ,$$

wherein θᵢ is the incident angle of the light beam, the incident angle (θᵢ) is defined by an included angle between a center line of the light beam and the normal line of the first transverse surface of the waveguide after the light beam occurs once total internal reflection in the waveguide, B is the initial divergence angle of the light beam, n is the refractive index of the waveguide, the refractive index of the waveguide is greater than 1, and the incident angle (θᵢ) is the same as the initial emergent angle (θ₀).

According to some embodiments of the present disclosure, the light beam is inclined relative to a normal line of the second transverse surface of the waveguide before coupling out from the waveguide, and the optical pattern includes from −1^{st} to −5^{th} order diffracted lights.

According to some embodiments of the present disclosure, the metasurface includes a plurality of pillars, and the pillars are arranged in asymmetric.

According to some embodiments of the present disclosure, an initial emergent angle of the light beam in the waveguide is 0 degree, and the initial emergent angle is defined by an included angle between a center line of the light beam and a normal line of the first transverse surface of the waveguide, wherein the waveguide further includes a mirror and an anti-reflection layer. The mirror is adjacent to the light source, wherein the mirror is configured to change an incident angle of the light beam for a total internal reflection in the waveguide, the mirror connects the first transverse surface and the second transverse surface, and the mirror is inclined relative to the first transverse surface of the waveguide. The anti-reflection layer is adjacent to the metasurface, wherein the anti-reflection layer is substantially perpendicular to both the first transverse surface and the second transverse surface.

According to some embodiments of the present disclosure, an inclined angle of the mirror is based on the following equation:

$$2 {θ}_{slope} = {θ}_{i} ,$$

wherein θₛₗₒₚₑ is the inclined angle of the mirror, θₛₗₒₚₑ is defined by an included angle between the mirror of the waveguide and the first transverse surface of the waveguide, θᵢ is an incident angle of the light beam on the first transverse surface of the waveguide, and θᵢ is defined by an included angle between the center line of the light beam and the normal line of first transverse surface of the waveguide after the light beam occurs once total internal reflection in the waveguide.

According to some embodiments of the present disclosure, an inclined angle of the mirror, the initial divergence angle of the light beam, and a refractive index of the waveguide satisfy the following equitation:

$$2 {θ}_{slope} - \frac{β}{2} \geq {sin}^{- 1} ( \frac{1}{n} ) ,$$

wherein θₛₗₒₚₑ is the inclined angle of the mirror, θₛₗₒₚₑ is defined by an included angle between the mirror of the waveguide and the first transverse surface of the waveguide, β is the initial divergence angle of the light beam, and n is the refractive index of the waveguide.

According to some embodiments of the present disclosure, the refractive index of the waveguide is greater than 1.

According to some embodiments of the present disclosure, a thickness of the waveguide is based on the following equation:

$${H}_{waveguide} = {W}_{source} \times tan ( {θ}_{slope} ) ,$$

wherein H_{waveguide} is the thickness of the waveguide, W_{source} is a width of the light source, θₛₗₒₚₑ is an inclined angle of the mirror, θₛₗₒₚₑ is defined by an included angle between the mirror of the waveguide and the first transverse surface of the waveguide.

According to some embodiments of the present disclosure, the light beam is inclined relative to a normal line of the second transverse surface of the waveguide before coupling out from the waveguide, and the optical pattern includes from −1^{st} to −5^{th} order diffracted lights.

According to some embodiments of the present disclosure, the metasurface includes a plurality of pillars, and the pillars are arranged in asymmetric.

According to some embodiments of the present disclosure, an initial emergent angle of the light beam in the waveguide is 0 degree, and the initial emergent angle is defined by an included angle between a center line of the light beam and a normal line of the first transverse surface of the waveguide, wherein the waveguide further includes a first mirror and a second mirror. The first mirror is adjacent to the light source, wherein the first mirror is configured to transmit the light beam parallel in the waveguide, the first mirror connects the first transverse surface and the second transverse surface, and the first mirror is inclined relative to the first transverse surface of the waveguide. The second mirror is adjacent to the metasurface, wherein the second mirror is configured to change the incident angle of the light beam on the second transverse surface in the waveguide to 0 degree, the incident angle of the light beam on the second transverse surface is defined by an included angle between a normal line of the second transverse surface and the center line of the light beam on the second transverse surface, the second mirror connects the first transverse surface and the second transverse surface, and the second mirror is inclined relative to the first transverse surface of the waveguide, wherein the first mirror is parallel to the second mirror.

According to some embodiments of the present disclosure, a thickness of the waveguide is based on the following equation:

$${H}_{waveguide} = {W}_{source} \times tan ( {θ}_{slope} ) ,$$

wherein H_{waveguide} is the thickness of the waveguide, W_{source} is a width of the light source, θₛₗₒₚₑ is an inclined angle of the mirror, θₛₗₒₚₑ is defined by an included angle between the mirror of the waveguide and the first transverse surface of the waveguide, and θₛₗₒₚₑ is 45 degrees.

According to some embodiments of the present disclosure, the light beam is perpendicular to the second transverse surface of the waveguide before coupling out from the waveguide, and the optical pattern further includes a zero order diffracted light, ±1 order diffracted lights, and ±2 order diffracted lights.

According to some embodiments of the present disclosure, a refractive index of the waveguide is greater than 1, the metasurface includes a plurality of pillars, and the pillars are arranged in symmetric.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view of a diffractive optical device in accordance with some embodiments of the present disclosure.

FIG. 2 is an enlargement view of the surface relief grating in FIG. 1.

FIG. 3 is a partial top view of the asymmetric metasurface in FIG. 1.

FIG. 4 is a cross-sectional view of a diffractive optical device in accordance with some embodiments of the present disclosure.

FIG. 5 is a cross-sectional view of a diffractive optical device in accordance with some embodiments of the present disclosure.

FIG. 6 is a partial top view of the symmetric metasurface in FIG. 5.

FIG. 7 is a top view of a package structure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. It should be understood that the number of any elements/components is merely for illustration, and it does not intend to limit the present disclosure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The present disclosure discloses three kinds of diffractive optical devices. In each diffractive optical device, a light emitting units directly contacts a transverse surface of a waveguide, a light beam can travel in the waveguide by total internal reflection (TIR) before coupling out through a metasurface to project an optical pattern (i.e., diffracted pattern) on a plane. In comparison with the traditional MOE or DOE system, the disclosed diffractive optical devices do not need a certain distance for the focal length to produce the optical pattern. Therefore, the disclosed diffractive optical device can satisfy continuously shrinking diffractive optical devices. The thickness of the disclosed diffractive optical devices is tens to hundreds of micrometers.

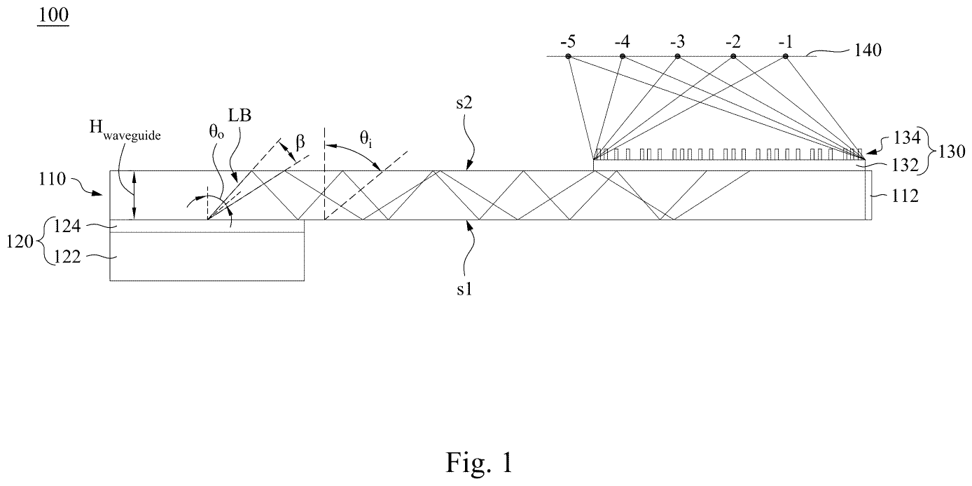

FIG. 1 is a cross-sectional view of a diffractive optical device 100 in accordance with some embodiments of the present disclosure. The diffractive optical device 100 includes a waveguide 110, a light emitting unit 120, and a metasurface 130. The waveguide 110 includes a first transverse surface s1 and a second transverse surface s2 opposite to the first transverse surface s1, in which the first transverse surface s1 is parallel to the second transverse surface s2. The light emitting unit 120 directly contacts the first transverse surface s1 of the waveguide 110, wherein the light emitting unit 120 includes a light source 122. The waveguide 110 is configured to emit a light beam LB with an initial divergence angle β. The metasurface 130 is disposed on the second transverse surface s2 of the waveguide 110, wherein the metasurface 130 is configured to couple out the light beam LB from the waveguide 110 and project an optical pattern on a plane 140, wherein the optical pattern includes a negative order diffracted light.

In some embodiments, the light source 122 includes a vertical cavity surface emitting laser (VCSEL) or a light emitting diode, but not limited thereto. In some embodiments, the light source 122 provides a transverse electric (TE) mode and/or a transverse magnetic (TM) mode of the light beam LB.

Referring to FIG. 1, the light emitting unit 120 further includes a surface relief grating (SRG) 124 disposed between the light source 122 and the waveguide 110. The surface relief grating 124 disposed on the light source 122. The surface relief grating 124 directly contacts the first transverse surface s1 of the waveguide 110, and the initial emergent angle θ₀ of the light beam LB in the waveguide 110 is not 0 degree. The initial emergent angle θ₀ is defined by an included angle between a center line of the light beam LB and a normal line of the first transverse surface s1 of the waveguide 110, as shown in FIG. 1. In other words, the initial emergent angle θ₀ is inclined relative to a normal line of the first transverse surface s1 of the waveguide 110. It could be understood that the light beam LB couples into the waveguide 110 with the initial emergent angle θ₀ and the initial divergence angle β.

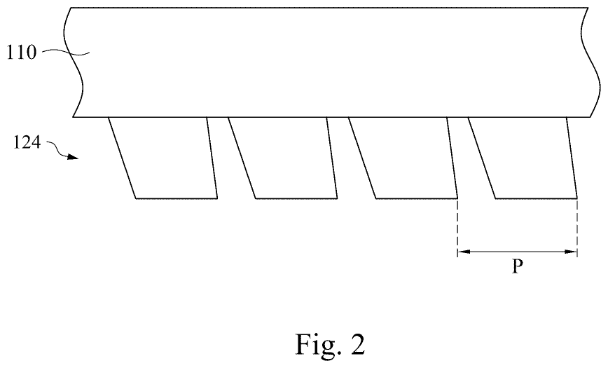

FIG. 2 is an enlargement view of the surface relief grating 124 in FIG. 1. The surface relief grating 124 includes a plurality of slanted structures. The slanted structures are configured to diffract the light beam LB from the air into the waveguide 110 with high efficiency. A pitch P of the slanted structures could be designed to adjust the incident angle θᵢ for satisfying the total internal reflection condition of the light beam LB occurring in the waveguide 110 (referring to FIG. 1).

Referring to FIG. 1, the incident angle θᵢ of the light beam LB, the initial divergence angle β of the light beam LB, and a refractive index of the waveguide 110 satisfy the following equitation:

$${θ}_{i} - \frac{β}{2} \geq {sin}^{- 1} ( \frac{1}{n} ) ,$$

wherein θᵢ is the incident angle of the light beam LB, the incident angle θᵢ is defined by an included angle between a center line of the light beam LB and the normal line of the first transverse surface s1 of the waveguide 110 after the light beam LB occurs once total internal reflection in the waveguide 110, β is the initial divergence angle of the light beam LB, n is the refractive index of the waveguide 110. When the incident angle θᵢ of the light beam LB, the initial divergence angle β of the light beam LB, and a refractive index of the waveguide 110 satisfy the above equitation, the light beam LB occurs total internal reflection in the waveguide 110. In some embodiments, the refractive index of the waveguide 110 is greater than 1, such as SiO₂ with 1.5, a-Si with 3.5 or Ta₂O₅ with 2.1. For example, a material of the waveguide 110 includes glass with a refractive index of 1.5. In some embodiments, the initial divergence angle β is about 15 degrees in VCSEL. In some embodiments, when the waveguide 110 with a refractive index of 1.5, the incident angle θᵢ is at least 49.3 degrees (i.e. θᵢ≥49.3 degrees). In the embodiment of the diffractive optical device 100, the incident angle θᵢ is the same as the initial emergent angle θ₀.

Referring to FIG. 1, the light beam LB is inclined relative to a normal line of the second transverse surface s2 of the waveguide 110 before coupling out from the waveguide 110. In other words, the center line of the light beam LB is inclined relative to the normal line of the second transverse surface s2. In some embodiments, the optical pattern on the plane 140 includes from −1^{st} to −5^{th} order diffracted lights. In other words, the light beam LB is coupled out through metasurface 130 to the air with a plurality of negative order diffracted lights. In some embodiments, an effective refraction index of the metasurface 130 is equal to or higher than the refractive index of the waveguide 110, so that the light beam LB can be coupled out.

Referring to FIG. 1, the waveguide 110 further includes an anti-reflection layer 112 adjacent to the metasurface 130, and the anti-reflection layer 112 is substantially perpendicular to both the first transverse surface s1 and the second transverse surface s2. Specifically, the anti-reflection layer 112 is disposed at an end of the waveguide 110. The anti-reflection layer 112 is configured to suppress a reflective light of the light beam LB from the end of waveguide 110, in which the reflective light would result in a crosstalk interference with an original light of light beam LB. Therefore, the anti-reflection layer 112 could avoid or reduce the crosstalk and increase a coupling efficiency of the diffractive optical device 100.

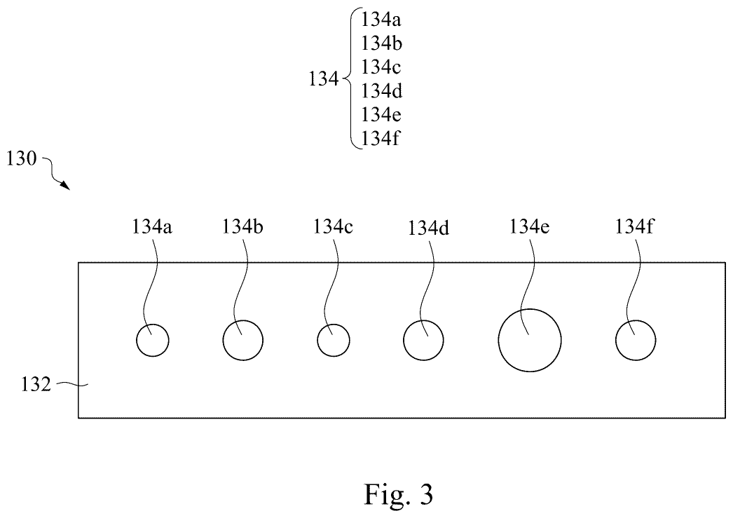

FIG. 3 is a partial top view of the asymmetric metasurface 130 in FIG. 1. Referring to FIG. 1 and FIG. 3, the metasurface 130 includes a substrate 132 and a plurality of pillars 134a-134f, and the pillars 134a-134f are arranged in asymmetric. As shown in FIG. 3, a diameter of each pillar 134a-134f can be designed and simulated by the Finite-Difference Time-Domain (FDTD). The metasurface 130 in FIG. 1 and FIG. 3 is designed with the asymmetric period structure due to the light beam LB with the incident angle θᵢ to the normal line of the second transverse surface s2 of the waveguide 110 and the required diffracted pattern occurred at negative order. As shown in FIG. 1, the metasurface 130 directly contacts the second transverse surface s2 of the waveguide 110. In some embodiments, a projection of the light emitting unit 120 on the waveguide 110 spaces apart from a projection of the metasurface 130 on the waveguide 110.

In some embodiments, the diffractive optical device 100 further includes a polarizer disposed between the surface relief grating 124 and the waveguide 110. The polarizer could make the light beam LB of a specific polarization pass through.

In the diffractive optical device 100 in FIG. 1, the light beam LB with the initial emergent angle θ₀ can make the light beam LB satisfy the total internal reflection condition in the waveguide 110, such that the light beam LB occurs total internal reflection in the waveguide 110. A thickness H_{waveguide} of the waveguide 110 is determined by a process capability. A total thickness the diffractive optical device 100 is the sum of a thickness of the light emitting unit 120, H_{waveguide}, and a thickness of the metasurface 130.

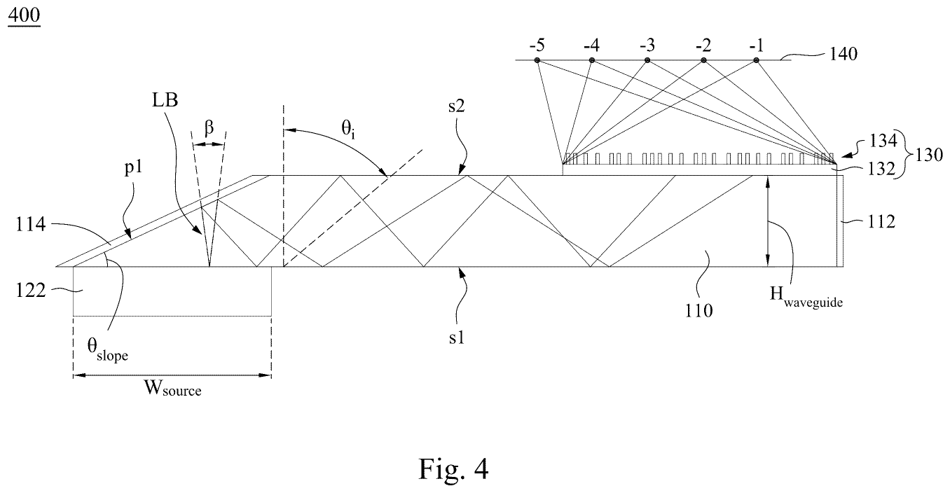

FIG. 4 is a cross-sectional view of a diffractive optical device 400 in accordance with some embodiments of the present disclosure. Same or similar features are labeled by the same numerical references, and descriptions of the same or similar features are not repeated in the following figures. In the diffractive optical device 400, the waveguide 110 further includes a mirror 114 adjacent to the light source 122. The mirror 114 is configured to change an incident angle of the light beam LB for a total internal reflection in the waveguide 110, the mirror 114 connects the first transverse surface s1 and the second transverse surface s2, and the mirror 114 is inclined relative to the first transverse surface s1 of the waveguide 110. In other words, the waveguide 110 has an inclined plane p1, and the mirror 114 is disposed on the inclined plane p1.

The waveguide 110 also includes the anti-reflection layer 112 adjacent to the metasurface 130, wherein the anti-reflection layer 112 is substantially perpendicular to both the first transverse surface s1 and the second transverse surface s2. The anti-reflection layer 112 is configured to suppress a reflective light of the light beam LB from the end of waveguide 110, in which the reflective light would result in a crosstalk interference with an original light of light beam LB. Therefore, the anti-reflection layer 112 could avoid or reduce the crosstalk and increase a coupling efficiency of the diffractive optical device 400.

Referring to FIG. 4, the initial emergent angle θ₀ of the light beam LB in the waveguide 110 is 0 degree, in which the initial emergent angle θ₀ is defined by the included angle between the center line of the light beam LB and the normal line of the first transverse surface s1 of the waveguide 110. In other words, the center line of the light beam LB is parallel to the normal line of the first transverse surface s1 of the waveguide. The perpendicular incidence of the light beam LB can help for increasing the coupling efficiency to approach the theoretical transmittance from the light source 122 to the first transverse surface s1, wherein the equation of the theoretical transmittance is {1-[(n−1)/(n+1)]²}*100%, and n is the refractive index of the waveguide 110. For example, the theoretical transmittance of the waveguide 110 is about 96% based on the refractive index of the waveguide at 1.5.

In some embodiments, an inclined angle θₛₗₒₚₑ of the mirror 114 is based on the following equation:

$$2 {θ}_{slope} = {θ}_{i} ,$$

wherein θₛₗₒₚₑ is the inclined angle of the mirror 114, θₛₗₒₚₑ is defined by an included angle between the mirror 114 of the waveguide 110 and the first transverse surface s1 of the waveguide 110, θᵢ is an incident angle of the light beam LB on the first transverse surface s1 of the waveguide 110, and θᵢ is defined by an included angle between a center line of the light beam LB and a normal line of first transverse surface s1 of the waveguide 110 after the light beam LB occurs once total internal reflection in the waveguide 110.

In some embodiments, the inclined angle θₛₗₒₚₑ of the mirror 114, the initial divergence angle β of the light beam LB, and the refractive index of the waveguide 110 satisfy the following equitation:

$$2 {θ}_{slope} - \frac{β}{2} \geq {sin}^{- 1} ( \frac{1}{n} ) ,$$

wherein θₛₗₒₚₑ is the inclined angle of the mirror 114, B is the initial divergence angle of the light beam LB, and n is the refractive index of the waveguide 110. In some embodiments, the refractive index of the waveguide 110 is greater than 1, such as SiO₂ with 1.5, a-Si with 3.5 or Ta₂O₅ with 2.1. When the inclined angle θₛₗₒₚₑ of the mirror 114, the initial divergence angle β of the light beam LB, and the refractive index of the waveguide 110 satisfy the above equitation, the light beam LB occurs total internal reflection in the waveguide 110. In some embodiments, the initial divergence angle β is about 15 degrees in VCSEL. In some embodiments, when the waveguide 110 with a refractive index of 1.5, the incident angle θᵢ is at least 49.3 degrees (i.e. θᵢ≥49.3 degrees) and the inclined angle θₛₗₒₚₑ is at least 24.65 degrees (i.e. θₛₗₒₚₑ≥24.65 degrees).

In some embodiments, a thickness H_{waveguide} of the waveguide 110 in the diffractive optical device 400 is based on the following equation:

$${H}_{waveguide} = {W}_{source} \times tan ( {θ}_{slope} ) ,$$

wherein H_{waveguide} is the thickness of the waveguide, W_{source} is a width of the light source 122, θₛₗₒₚₑ is an inclined angle of the mirror 114. In the embodiment of diffractive optical device 400, when the waveguide 110 with a refractive index of 1.5, the inclined angle θₛₗₒₚₑ is at least 24.65 degrees, and the minimum thickness H_{waveguide} of the waveguide 110 is about 0.46×W_{source}.

Referring to FIG. 4, the light beam LB is inclined relative to a normal line of the second transverse surface s2 of the waveguide 110 before coupling out from the waveguide 110. In other words, the center line of the light beam LB is inclined relative to the normal line of the second transverse surface s2. In some embodiments, the optical pattern on the plane 140 includes from −1^{st} to −5^{th} order diffracted lights.

Referring to FIG. 3 and FIG. 4, the metasurface 130 also includes the plurality of pillars 134a-134f, and the pillars 134a-134f are arranged in asymmetric. The metasurface 130 in FIG. 3 and FIG. 4 is designed with the asymmetric period structure due to the light beam LB with the incident angle θᵢ to the normal line of the second transverse surface s2 of the waveguide 110 and the required diffracted pattern occurred at negative order.

In the diffractive optical device 400 in FIG. 4, the sloped mirror 114 can change the optical path of the light beam LB and satisfy the total internal reflection condition in the waveguide 110, such that the light beam LB occurs total internal reflection in the waveguide 110. A total thickness the diffractive optical device 400 is the sum of a thickness of the light source 122, H_{waveguide}, and a thickness of the metasurface 130.

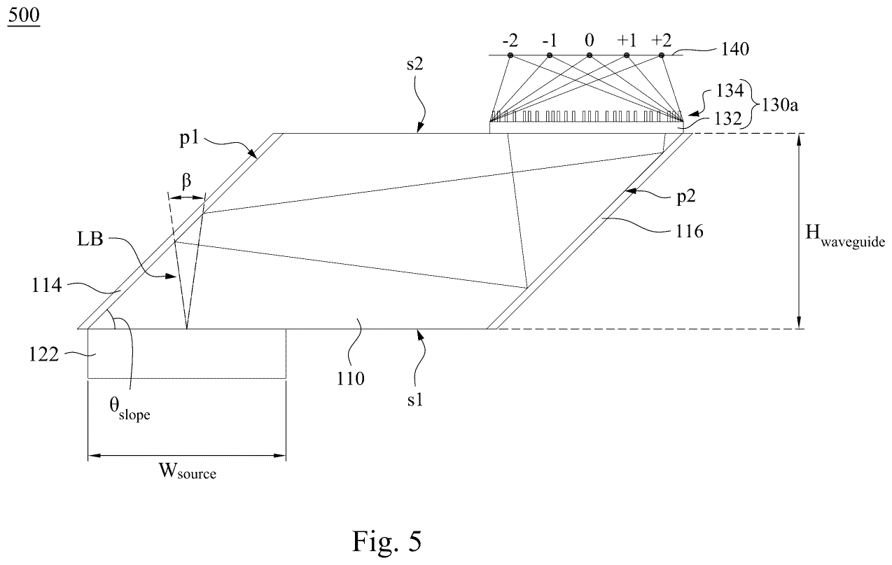

FIG. 5 is a cross-sectional view of a diffractive optical device 500 in accordance with some embodiments of the present disclosure. In the diffractive optical device 500, the waveguide 110 includes a mirror 114 adjacent to the light source 122 and a mirror 116 is adjacent to a metasurface 130a. The waveguide 110 has the inclined plane p1 and an inclined plane p2, and the mirror 114 is disposed on the inclined plane p1 and the mirror 116 is disposed on the inclined plane p2.

The mirror 114 connects the first transverse surface s1 and the second transverse surface s2, and the mirror 114 is inclined relative to the first transverse surface s1 of the waveguide 110. The mirror 114 is configured to transmit the light beam LB parallel in the waveguide 110 after 1^{st} total internal reflection. Specifically, after 1^{st} total internal reflection, the center line of the light beam LB is parallel to the first transverse surface s1 and the second transverse surface s2 of the waveguide 110. The mirror 116 connects the first transverse surface s1 and the second transverse surface s2, and the mirror 116 is inclined relative to the first transverse surface s1 of the waveguide 110. The mirror 116 is configured to change an incident angle of the light beam LB on the second transverse surface s2 in the waveguide 110 to 0 degree after 2^{nd} total internal reflection, wherein the incident angle of the light beam LB on the second transverse surface s2 is defined by an included angle between a normal line of the second transverse surface s2 and the center line of the light beam LB on the second transverse surface s2. In other words, an included angle between the center line of the light beam LB and the normal line of the second transverse surface s2 is 0 degree. In the embodiment of the diffractive optical device 500, the mirror 114 is parallel to the mirror 116. There is no anti-reflection layer in the diffractive optical device 500.

Referring to FIG. 5, the initial emergent angle θ₀ of the light beam LB in the waveguide is 0 degree, in which the initial emergent angle θ₀ is defined by the included angle between the center line of the light beam LB and the normal line of the first transverse surface s1 of the waveguide 110. In other words, the center line of the light beam LB is parallel to the normal line of the first transverse surface s1 of the waveguide.

In some embodiments, a thickness H_{waveguide} of the waveguide 110 in the diffractive optical device 500 is based on the following equation:

$${H}_{waveguide} = {W}_{source} \times tan ( {θ}_{slope} ) ,$$

wherein H_{waveguide} is the thickness of the waveguide 110, W_{source} is a width of the light source 122, θₛₗₒₚₑ is an inclined angle of the mirror 114, θₛₗₒₚₑ is defined by an included angle between the mirror 114 of the waveguide 110 and the first transverse surface s1 of the waveguide 110, and θₛₗₒₚₑ is 45 degrees. In other words, the thickness H_{waveguide} is equal to W_{source}.

In the embodiment of the diffractive optical device 500, the light beam LB is perpendicular to the second transverse surface s2 of the waveguide 110 before coupling out from the waveguide 110. In other words, the center line of the light beam LB is parallel to the normal line of the second transverse surface s2. In some embodiments, the optical pattern on the plane 140 includes a zero order diffracted light, ±1 order diffracted lights, and ±2 order diffracted lights.

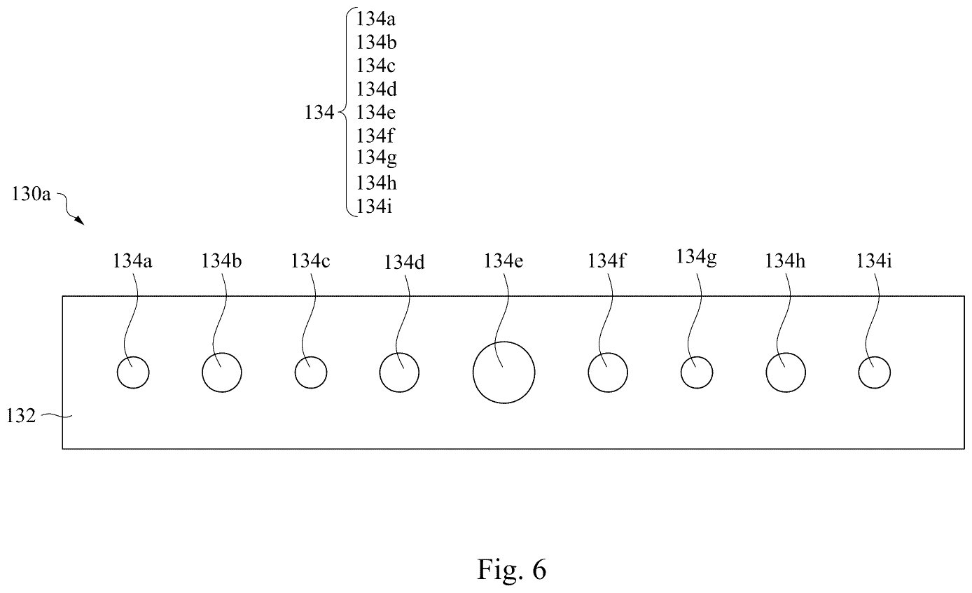

FIG. 6 is a partial top view of the symmetric metasurface 130a in FIG. 5. Referring to FIG. 5 and FIG. 6, the metasurface 130a includes the substrate 132 and a plurality of pillars 134a-134i, and the pillars 134a-134i are arranged in symmetric. In other words, the pillar 134e can be seen as a symmetry center. In some embodiments, an effective refractive index of the metasurface 130a is equal to or higher than the refractive index of the waveguide 110, so that the light beam LB can be coupled out.

In the diffractive optical device 500 in FIG. 5, the input coupling of the light beam LB is perpendicular to the first transverse surface s1 of the waveguide 110, and the output coupling of the light beam LB is perpendicular to the second transverse surface s2 of the waveguide 110. Therefore, the diffractive optical device 500 can minimize the loss of the coupling efficiency, thereby increasing its coupling efficiency. In addition, the light beam LB between the mirror 114 and the mirror 116 is parallel to the first transverse surface s1 and the second transverse surface s2, so the diffractive optical device 500 can minimize the propagation loss. Because θₛₗₒₚₑ is 45 degrees and the initial emergent angle of the light beam LB to the metasurface 130 is 0 degree, the coupling efficiency of the diffractive optical device 500 from waveguide 110 to metasurface 130 can be maximized. A total thickness the diffractive optical device 500 is the sum of the thickness of the light source 122, H_{waveguide}, and a thickness of the metasurface 130a.

The disclosed diffractive optical devices 100, 400, and 500 can be applied in display field (such as augmented reality (AR), virtual reality (VR), 2D sensing, 3D sensing, and cameras) and silicon photonics field (such as light detection and ranging (LiDAR), light coupling and guiding, and packages).

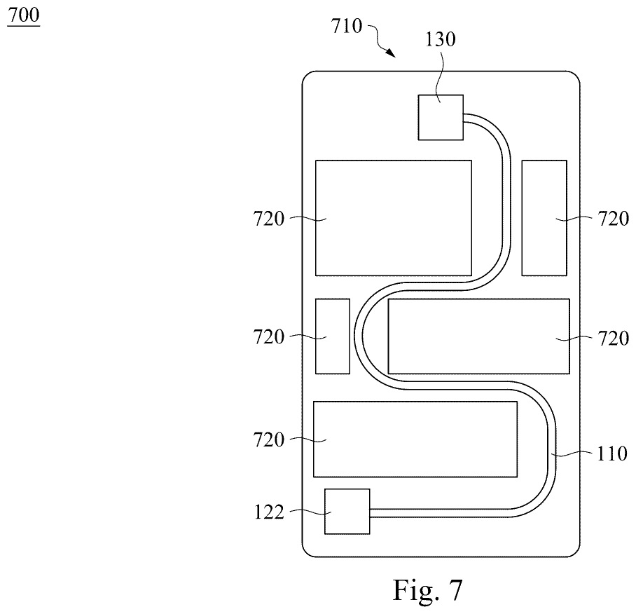

FIG. 7 is a top view of a package structure 700. The package structure 700 includes the diffractive optical device 710 and a plurality of devices 720. It could be understood that the number and arrangement of devices 720 are merely for illustration. In the diffractive optical device 710 of the package structure 700, the waveguide 110 is a curved waveguide. Specifically, an extension direction of the waveguide 110 can be adjusted according to arrangement of the devices 720, so that a waveguide path can be constructed with the shortest path in the package structure 700. The diffractive optical device 710 can be the above-mentioned diffractive optical device 100, 400, or 500. In the diffractive optical device 100, 400, or 500, the waveguides 110 can be planar waveguides. Therefore, the diffractive optical devices 100, 400, 500, and 710 have high compatibility to match different spaces.

In each of the diffractive optical devices of the present disclosure, the light beam can travel in the waveguide by total internal reflection before coupling out through the metasurface. Since the light emitting unit directly contacts the transverse surface of the waveguide, a thickness of the disclosed diffractive optical device can be reduced compared to the traditional MOE or DOE system. Therefore, the disclosed diffractive optical device can satisfy continuously shrinking diffractive optical devices.

The present disclosure has been disclosed as hereinabove, however it is not used to limit the present disclosure. Those skilled in the art may make various changes, substitutions, and alterations herein without departing from the spirit and scope of the present disclosure. Therefore, the scope of protection of the present disclosure shall be subject to the scope of the claim attached in the application and its equivalent constructions.

What is claimed is:

1. A diffractive optical device, comprising:
a waveguide comprising a first transverse surface and a second transverse surface opposite to the first transverse surface;
a light emitting unit directly contacting the first transverse surface of the waveguide configured to emit a light beam with an initial divergence angle, wherein the light emitting unit comprises a light source and; and
a metasurface disposed on the second transverse surface of the waveguide, wherein the metasurface is configured to couple out the light beam from the waveguide and project an optical pattern on a plane, wherein the optical pattern comprises a negative order diffracted light.

2. The diffractive optical device of claim 1, wherein the light source comprises a vertical cavity surface emitting laser or a light emitting diode.

3. The diffractive optical device of claim 1, wherein the waveguide comprises a planar waveguide or a curved waveguide.

4. The diffractive optical device of claim 1, wherein the light emitting unit further comprises a surface relief grating, the surface relief grating is disposed between the light source and the waveguide and directly contacts the first transverse surface of the waveguide, and an initial emergent angle (θ₀) of the light beam in the waveguide is not 0 degree, wherein the initial emergent angle is defined by an included angle between a center line of the light beam and a normal line of the first transverse surface.

5. The diffractive optical device of claim 4, wherein the surface relief grating comprises a plurality of slanted structures.

6. The diffractive optical device of claim 4, wherein the waveguide further comprises an anti-reflection layer adjacent to the metasurface, and the anti-reflection layer is substantially perpendicular to both the first transverse surface and the second transverse surface.

7. The diffractive optical device of claim 4, wherein an incident angle of the light beam, the initial divergence angle of the light beam, and a refractive index of the waveguide satisfy the following equitation:
$${θ}_{i} - \frac{β}{2} \geq {sin}^{- 1} ( \frac{1}{n} ) ,$$
wherein θᵢ is the incident angle of the light beam, the incident angle is defined by an included angle between a center line of the light beam and the normal line of the first transverse surface of the waveguide after the light beam occurs once total internal reflection in the waveguide, β is the initial divergence angle of the light beam, n is the refractive index of the waveguide, the refractive index of the waveguide is greater than 1, and the incident angle (θᵢ) is the same as the initial emergent angle (θ₀).

8. The diffractive optical device of claim 4, wherein the light beam is inclined relative to a normal line of the second transverse surface of the waveguide before coupling out from the waveguide, and the optical pattern comprises from −1^{st} to −5^{th} order diffracted lights.

9. The diffractive optical device of claim 4, wherein the metasurface comprises a plurality of pillars, and the pillars are arranged in asymmetric.

10. The diffractive optical device of claim 1, wherein an initial emergent angle of the light beam in the waveguide is 0 degree, and the initial emergent angle is defined by an included angle between a center line of the light beam and a normal line of the first transverse surface of the waveguide, wherein the waveguide further comprises:
a mirror adjacent to the light source, wherein the mirror is configured to change an incident angle of the light beam for a total internal reflection in the waveguide, the mirror connects the first transverse surface and the second transverse surface, and the mirror is inclined relative to the first transverse surface of the waveguide; and
an anti-reflection layer adjacent to the metasurface, wherein the anti-reflection layer is substantially perpendicular to both the first transverse surface and the second transverse surface.

11. The diffractive optical device of claim 10, wherein an inclined angle of the mirror is based on the following equation:
$$2 {θ}_{slope} = {θ}_{i} ,$$
wherein θₛₗₒₚₑ is the inclined angle of the mirror, θₛₗₒₚₑ is defined by an included angle between the mirror of the waveguide and the first transverse surface of the waveguide, θᵢ is an incident angle of the light beam on the first transverse surface of the waveguide, and θᵢ is defined by an included angle between the center line of the light beam and the normal line of first transverse surface of the waveguide after the light beam occurs once total internal reflection in the waveguide.

12. The diffractive optical device of claim 10, wherein an inclined angle of the mirror, the initial divergence angle of the light beam, and a refractive index of the waveguide satisfy the following equitation:
$$2 {θ}_{slope} - \frac{β}{2} \geq {sin}^{- 1} ( \frac{1}{n} ) ,$$
wherein θₛₗₒₚₑ is the inclined angle of the mirror, θₛₗₒₚₑ is defined by an included angle between the mirror of the waveguide and the first transverse surface of the waveguide, B is the initial divergence angle of the light beam, and n is the refractive index of the waveguide.

13. The diffractive optical device of claim 12, wherein the refractive index of the waveguide is greater than 1.

14. The diffractive optical device of claim 10, wherein a thickness of the waveguide is based on the following equation:
$${H}_{waveguide} = {W}_{source} \times tan ( {θ}_{slope} ) ,$$
wherein H_{waveguide} is the thickness of the waveguide, W_{source} is a width of the light source, θₛₗₒₚₑ is an inclined angle of the mirror, θₛₗₒₚₑ is defined by an included angle between the mirror of the waveguide and the first transverse surface of the waveguide.

15. The diffractive optical device of claim 10, wherein the light beam is inclined relative to a normal line of the second transverse surface of the waveguide before coupling out from the waveguide, and the optical pattern comprises from −1^{st} to −5^{th} order diffracted lights.

16. The diffractive optical device of claim 10, wherein the metasurface comprises a plurality of pillars, and the pillars are arranged in asymmetric.

17. The diffractive optical device of claim 1, wherein an initial emergent angle of the light beam in the waveguide is 0 degree, and the initial emergent angle is defined by an included angle between a center line of the light beam and a normal line of the first transverse surface of the waveguide, wherein the waveguide further comprises:
a first mirror adjacent to the light source, wherein the first mirror is configured to transmit the light beam parallel in the waveguide, the first mirror connects the first transverse surface and the second transverse surface, and the first mirror is inclined relative to the first transverse surface of the waveguide; and
a second mirror adjacent to the metasurface, wherein the second mirror is configured to change an incident angle of the light beam on the second transverse surface in the waveguide to 0 degree, the incident angle of the light beam on the second transverse surface is defined by an included angle between a normal line of the second transverse surface and the center line of the light beam on the second transverse surface, the second mirror connects the first transverse surface and the second transverse surface, and the second mirror is inclined relative to the first transverse surface of the waveguide, wherein the first mirror is parallel to the second mirror.

18. The diffractive optical device of claim 17, wherein a thickness of the waveguide is based on the following equation:
$${H}_{waveguide} = {W}_{source} \times tan ( {θ}_{slope} ) ,$$
wherein H_{waveguide} is the thickness of the waveguide, W_{source} is a width of the light source, θₛₗₒₚₑ is an inclined angle of the mirror, θₛₗₒₚₑ is defined by an included angle between the mirror of the waveguide and the first transverse surface of the waveguide, and θₛₗₒₚₑ is 45 degrees.

19. The diffractive optical device of claim 18, wherein the light beam is perpendicular to the second transverse surface of the waveguide before coupling out from the waveguide, and the optical pattern further comprises a zero order diffracted light, ±1 order diffracted lights, and ±2 order diffracted lights.

20. The diffractive optical device of claim 18, wherein a refractive index of the waveguide is greater than 1, the metasurface comprises a plurality of pillars, and the pillars are arranged in symmetric.
